(19) United States
(12) Patent Application Publication
(10) Pub. No.: US 2024/0210634 A1
(43) Pub. Date: Jun. 27, 2024

(54) FUNCTIONALLY GRADED INDEX MOLD FOR CO-PACKAGED OPTICAL APPLICATIONS

(71) Applicant: Intel Corporation, Santa Clara, CA (US)

(72) Inventors: Zhixin XIE, Chandler, AZ (US); Jung Kyu HAN, Chandler, AZ (US); Gang DUAN, Chandler, AZ (US)

(21) Appl. No.: 18/089,501

(22) Filed: Dec. 27, 2022

(51) Int. Cl. G02B 6/42; G02B 1/04; G02B 3/00

(52) U.S. Cl. CPC G02B 6/4206; G02B 1/041; G02B 3/0087; G02B 6/4214; G02B 6/428

(57) ABSTRACT

Embodiments disclosed herein include a package substrate. In an embodiment, the package substrate comprises a substrate and an optical fiber in the substrate. In an embodiment, a lens is optically coupled to the optical fiber. In an embodiment, the lens is a gradient index (GRIN) lens.

### TECHNICAL FIELD

Embodiments of the present disclosure relate to electronic packages, and more particularly to co-packaged optical applications that include a graded index lens for improved coupling efficiency.

### BACKGROUND

With the rapidly growing demands of data transfer bandwidth and rate, optical fibers and photonic integrated circuits (PICs) are used together with electronic integrated circuits (ICs) as a co-packaged chip. The PIC integrates multiple optical signal transmitting and processing functions. However, coupling of the PIC to optical fibers is not as mature as electronic IC assembly technology. Optical packaging has much higher demands for assembly process accuracy due to the nature of optical signal loss.

To achieve low signal loss in PIC coupling (e.g., less than 2 dB), the placement accuracy tolerance is on the micron scale with an angle tolerance less than two degrees. This applies for both butt coupling architecture and evanescent coupling architectures. Unfortunately, this level of precise alignment with very tight tolerances suffers from poor yield and high equipment costs. As such, high volume manufacture of such architectures is severely limited.

Existing solutions for dealing with the tight tolerances is to use wedge-shaped recesses or precisely machined V-groove architectures. Micro-fabricated self-aligned curved mirror couplers may further enhance coupling efficiency. However, V-groove architectures require relatively complicated processing steps, including micro-machining and polishing. Self-aligned mirrors require photolithography, etching and polishing steps to fabricate well-controlled 3D shapes. This adds more fabrication difficulty and cost to the overall process. Also, one of the shortcomings of using an inserted or fabricated coupler is the high insertion loss, which is partially due to the high roughness of the coupling surfaces.

### BRIEF DESCRIPTION OF THE DRAWINGS

FIG. 1A is a cross-sectional illustration and a plan view illustration of a lens that includes a graded index of refraction, in accordance with an embodiment.

FIG. 1B is a cross-sectional illustration of an optical fiber coupled to a lens that includes a graded index of refraction, in accordance with an embodiment.

FIG. 2 is a cross-sectional illustration of an optical package that includes an optical fiber in the substrate core with a lens that includes a graded index of refraction, in accordance with an embodiment.

FIG. 3 is a cross-sectional illustration of an optical package that includes an optical fiber in the buildup layers with a lens that includes a graded index of refraction, in accordance with an embodiment.

FIG. 4 is a cross-sectional illustration of an optical package that includes an optical fiber that is butt coupled to a lens with a graded index of refraction, in accordance with an embodiment.

FIGS. 5A-5E are cross-sectional illustrations depicting a process for forming a lens with a graded index of refraction using a diffusion process, in accordance with an embodiment.

FIGS. 6A-6B are cross-sectional illustrations depicting a process for forming a lens with a graded index of refraction using an additive manufacturing process, in accordance with an embodiment.

FIG. 7 is a cross-sectional illustration of a lens with a graded index of refraction with a plurality of discrete layers, in accordance with an embodiment.

FIGS. 8A-8E are cross-sectional illustrations depicting a process for forming an optical package with a discrete graded index or refraction lens, in accordance with an embodiment.

FIG. 9 is a cross-sectional illustration of a computing system with co-packaged optical and electrical dies that include a lens with a graded index of refraction, in accordance with an embodiment.

FIG. 10 is a schematic of a computing device built in accordance with an embodiment.

### EMBODIMENTS OF THE PRESENT DISCLOSURE

Described herein are co-packaged optical applications that include a graded index lens for improved coupling efficiency, in accordance with various embodiments. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

As noted above, optical coupling in package substrates requires precise alignment in order to obtain satisfactory coupling efficiency. Existing solutions, such as V-grooves and the like can provide alignment that approaches necessary alignment accuracy. However, such solutions are complex to integrate into the package substrate, and can raise the cost of manufacture.

Accordingly, embodiments disclosed herein include lenses that have a graded index of refraction. So called gradient index (GRIN) lenses comprise a graded refractive index profile along the radius direction that enables self-focusing and/or collimation. An advantage of GRIN lenses over conventional curved collimators is that the lens surfaces are entirely planar. This eases the cavity forming and subsequent polishing process. Accordingly, easier assembly processes and smaller form factors are enabled.

In an embodiment, GRIN lenses are integrated as part of a photonics integrated circuit (PIC) package. In some instances, the GRIN lens is inserted as part of a mold layer or buildup layer of the PIC package. Such solutions improve the optical coupling efficiency by avoiding lateral offset and angular tilt misalignments of fiber coupling systems, and limit delamination.

The GRIN lens can be formed with various processing operations. In one instance liquid pre-polymer layers are disposed over each other. The liquid pre-polymers are allowed to diffuse in order to provide a gradient. Laser controlled polymerization can then be used to form the lens. UV photopolymerization may also be used in some embodiments. The various layers may be formed with an ink jetting process, an aerosol jetting process, or by a vapor deposition process. Thus, the fabrication of the GRIN lens can be controlled with relatively high reproducibility.

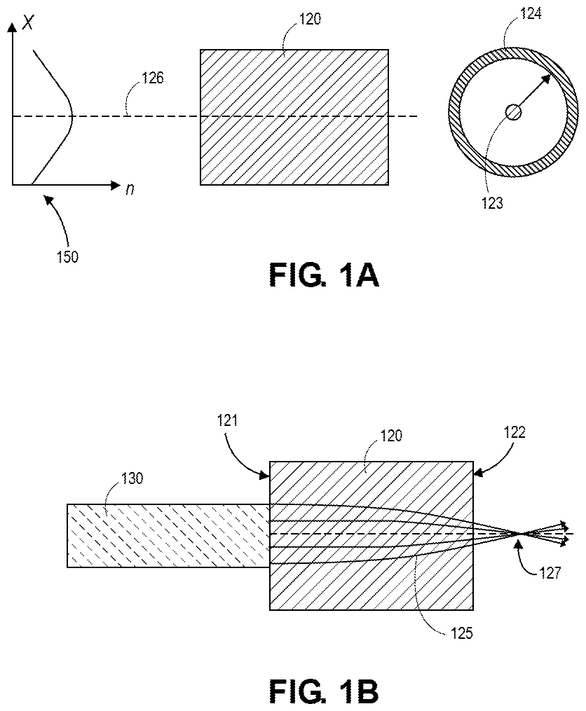

Referring now to FIG. 1A, an illustration of a GRIN lens 120 is shown, in accordance with an embodiment. The illustration of the GRIN lens 120 is shown with a uniform shading. However, it is to be appreciated that the GRIN lens 120 has a gradient index of refraction. The gradient is illustrated in the graph 150. As shown, the centerline 126 of the GRIN lens 120 has a higher refractive index n than the outer edges of the GRIN lens 120. In an embodiment, the refractive index n can be modulated by controlling the material composition of the GRIN lens 120. As will be described in greater detail below, various processing operations may be used in order to provide the graded material composition that enables the graded refractive index n.

As shown in the plan view illustration on the right, a core 123 of the GRIN lens 120 may be a first polymer composition, and an outermost ring 124 of the GRIN lens 120 may be a second polymer composition. As indicated by the arrow, the material composition transitions from the first material composition of the core 123 to the second material composition of the outermost ring 124. For example, a diffusion process may be used to provide the desired gradient.

Referring now to FIG. 1B, a cross-sectional illustration of an optical fiber 130 coupled to the GRIN lens 120 is shown, in accordance with an embodiment. The optical fiber 130 may be a glass fiber or the like. While shown in isolation in FIG. 1B, it is to be appreciated that the optical fiber 130 may be embedded in a PIC package substrate, such as the core or the buildup layers. As shown, optical signals 125 that propagate out of the optical fiber 130 enter the GRIN lens 120. The GRIN lens 120 focuses the optical signals 125 to a point 127 that is outside of the GRIN lens 120. As such, the optical signals 125 can be focused in order to improve coupling efficiency. In the reverse direction, optical signals 125 can be collimated.

In an embodiment, the focusing and collimating of the optical signals 125 is enabled even though the GRIN lens 120 does not include curved surfaces. For example, the surfaces incident to the path of the optical signals may be substantially planar. That is, surface 121 and surface 122 are substantially planar. Further, the surface 121 may be substantially parallel to the surface 122. Such planar surfaces are easier to manufacture and integrate into the PIC package, as will be described in greater detail below.

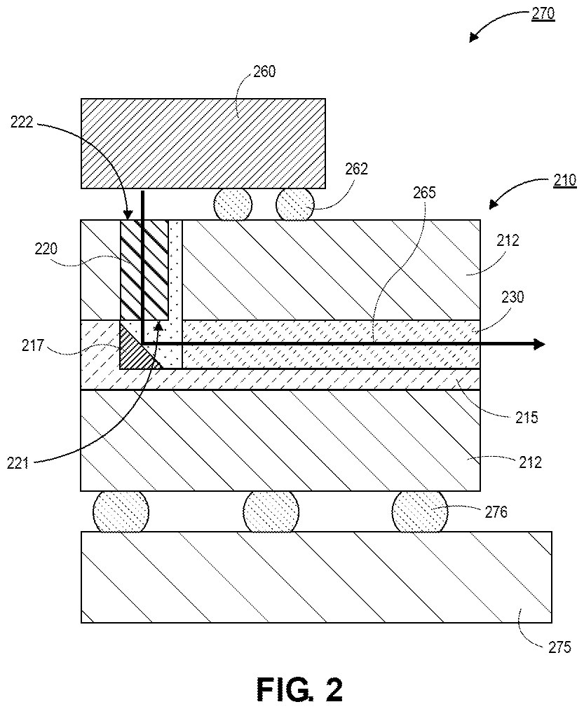

Referring now to FIG. 2, a cross-sectional illustration of a PIC package 270 is shown, in accordance with an embodiment. In an embodiment, the PIC package 270 comprises a package substrate 210. The package substrate 210 may include a core 215 and buildup layers 212 above and below the core 215. The core 215 may be any suitable core material, such as a glass core, an organic core, or the like. The buildup layers 212 may comprise buildup film, molding material, or the like.

In a particular embodiment shown in FIG. 2, the optical fiber 230 is embedded in the core 215. In the case of a glass core 215, the optical fiber 230 may have a different index of refraction in order to provide total internal reflection of optical signal 265. In the case of an organic core 215, the core 215 provides a cladding around the optical fiber 230.

In an embodiment, a GRIN lens 220 may be optically coupled to the optical fiber 230. As used herein, “optically coupled” may refer to two components that lie along the same optical path. For example, optical signal 265 passes through both the GRIN lens 220 and the optical fiber 230. In a particular embodiment, a mirror 217 or the like may be provided along the path of the optical signal 265 between the GRIN lens 220 and the optical fiber 230. The mirror 217 allows for the optical signal 265 to be turned. As such, the optical path through the GRIN lens 220 may be substantially orthogonal to the optical path through the optical fiber 230.

In an embodiment, the GRIN lens 220 has a graded index of refraction similar to embodiments described in greater detail above. Particularly, the gradation is a radial grading so that the grading starts at a first index of refraction at a radial center and changes to a second index of refraction at a radial edge. The second index of refraction may be smaller than the first index of refraction. Further, the GRIN lens 220 may have a first surface 221 and a second surface 222. The first surface 221 and the second surface 222 may be substantially planar and parallel to each other. In an embodiment, the GRIN lens 220 may be inserted into a hole or cavity through the buildup layers 212.

In an embodiment, the PIC package 270 may further comprise a PIC 260. The PIC 260 may be coupled to the package substrate 210 with interconnects 262. The interconnects 262 may be any suitable first level interconnect (FLI) architecture. The PIC 260 may also have a light source (e.g., a laser) and/or light detector (e.g., photodiode) that are optically coupled along the path of the optical signal 265. The PIC 260 may include functionality for converting optical signals into electrical signals and/or functionality for converting electrical signals into the optical signals. The PIC 260 may be electrically coupled to a compute die (not shown in FIG. 2).

In an embodiment, the package substrate 210 may further be coupled to a board 275, such as a printed circuit board (PCB). The board 275 may be coupled to the package substrate 210 through interconnects 276, such as solder interconnects, sockets, or any other suitable interconnect architecture.

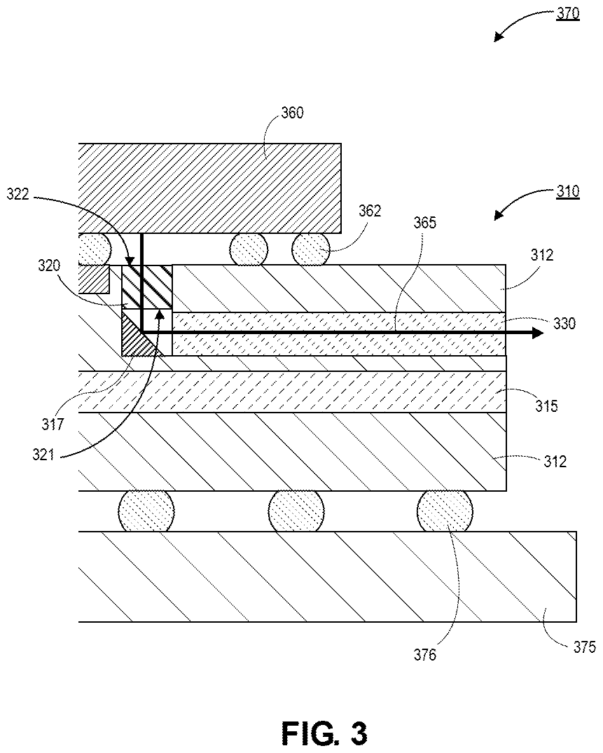

Referring now to FIG. 3, a cross-sectional illustration of a PIC package 370 is shown, in accordance with an embodiment. In an embodiment, the PIC package 370 comprises a package substrate 310. The package substrate 310 may include a core 315 and buildup layers 312 above and below the core 315. The core 315 may be any suitable core material, such as a glass core, an organic core, or the like. The buildup layers 312 may comprise buildup film, molding material, or the like.

In a particular embodiment shown in FIG. 3, the optical fiber 330 is embedded in the buildup layers 312 above the core. The optical fiber 330 may be a glass fiber that is embedded within the buildup layers 312 using any suitable assembly process.

In an embodiment, a GRIN lens 320 may be optically coupled to the optical fiber 330. In a particular embodiment, a mirror 317 or the like may be provided along the path of the optical signal 365 between the GRIN lens 320 and the optical fiber 330. The mirror 317 allows for the optical signal 365 to be turned. As such, the optical path through the GRIN lens 320 may be substantially orthogonal to the optical path through the optical fiber 330.

In an embodiment, the GRIN lens 320 has a graded index of refraction similar to embodiments described in greater detail above. Particularly, the gradation is a radial grading so that the grading starts at a first index of refraction at a radial center and changes to a second index of refraction at a radial edge. The second index of refraction may be smaller than the first index of refraction. Further, the GRIN lens 320 may have a first surface 321 and a second surface 322. The first surface 321 and the second surface 322 may be substantially planar and parallel to each other. In an embodiment, the GRIN lens 320 may be inserted into a hole or cavity through the buildup layers 312.

In an embodiment, the PIC package 370 may further comprise a PIC 360. The PIC 360 may be coupled to the package substrate 310 with interconnects 362. The interconnects 362 may be any suitable FLI architecture. The PIC 360 may also have a light source (e.g., a laser) and/or light detector (e.g., photodiode) that are optically coupled along the path of the optical signal 365. The PIC 360 may include functionality for converting optical signals into electrical signals and/or functionality for converting electrical signals into the optical signals. The PIC 360 may be electrically coupled to a compute die (not shown in FIG. 3).

In an embodiment, the package substrate 310 may further be coupled to a board 375, such as a PCB. The board 375 may be coupled to the package substrate 310 through interconnects 376, such as solder interconnects, sockets, or any other suitable interconnect architecture.

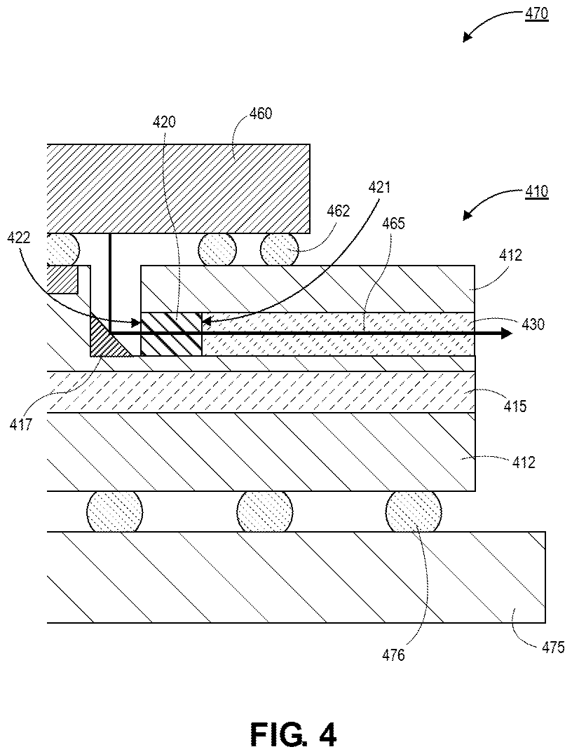

Referring now to FIG. 4, a cross-sectional illustration of a PIC package 470 is shown, in accordance with an additional embodiment. In an embodiment, the PIC package 470 comprises a package substrate 410. The package substrate 410 may include a core 415 and buildup layers 412 above and below the core 415. The core 415 may be any suitable core material, such as a glass core, an organic core, or the like. The buildup layers 412 may comprise buildup film, molding material, or the like.

In a particular embodiment shown in FIG. 4, the optical fiber 430 is embedded in the buildup layers 412 above the core. The optical fiber 430 may be a glass fiber that is embedded within the buildup layers 412 using any suitable assembly process.

In an embodiment, a GRIN lens 420 may be optically coupled to the optical fiber 430. More generally, the GRIN lens 420 may be oriented so that a first surface 421 is directly contacting an end of the optical fiber 430. That is, the GRIN lens 420 may be butt coupled to the optical fiber 430. In an embodiment, a mirror 417 or the like may be provided along the path of the optical signal 465 between the GRIN lens 420 and the PIC 460. The mirror 417 allows for the optical signal 465 to be turned so that the optical signal passes horizontally through both the GRIN lens 420 and the optical fiber 430.

In an embodiment, the GRIN lens 420 has a graded index of refraction similar to embodiments described in greater detail above. Particularly, the gradation is a radial grading so that the grading starts at a first index of refraction at a radial center and changes to a second index of refraction at a radial edge. The second index of refraction may be smaller than the first index of refraction. Further, the GRIN lens 420 may have a first surface 421 and a second surface 422. The first surface 421 and the second surface 422 may be substantially planar and parallel to each other. In an embodiment, the GRIN lens 420 may be embedded in the buildup layers 412.

In an embodiment, the PIC package 470 may further comprise a PIC 460. The PIC 460 may be coupled to the package substrate 410 with interconnects 462. The interconnects 462 may be any suitable FLI architecture. The PIC 460 may also have a light source (e.g., a laser) and/or light detector (e.g., photodiode) that are optically coupled along the path of the optical signal 465. The PIC 460 may include functionality for converting optical signals into electrical signals and/or functionality for converting electrical signals into the optical signals. The PIC 460 may be electrically coupled to a compute die (not shown in FIG. 4).

In an embodiment, the package substrate 410 may further be coupled to a board 475, such as a PCB. The board 475 may be coupled to the package substrate 410 through interconnects 476, such as solder interconnects, sockets, or any other suitable interconnect architecture.

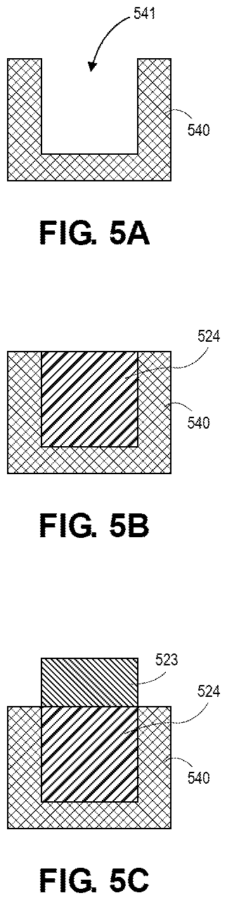

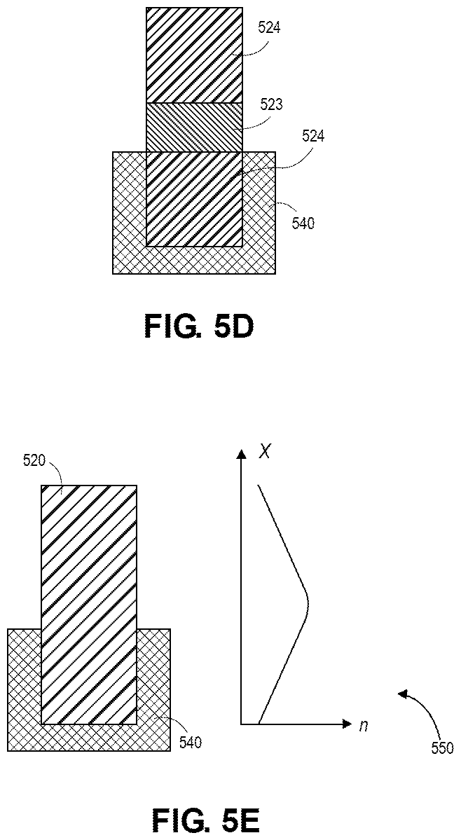

Referring now to FIGS. 5A-5E, a series of cross-sectional illustrations depicting a process for forming a GRIN lens 520 is shown, in accordance with an embodiment. In the illustrated embodiment, a diffusion process is used in order to enable the formation of a refractive index gradient between the center and edge of the GRIN lens 520.

Referring now to FIG. 5A, a cross-sectional illustration of a cavity 541 into a substrate 540 is shown, in accordance with an embodiment. In an embodiment, the cavity 541 may be formed in any type of substrate 540 that allows for easy release of the finished GRIN lens 520. For example, the substrate 540 may be a glass substrate 540 or the like. More generally, the substrate 540 is a discrete component from the PIC package. That is, the GRIN lens 520 is formed as a discrete component that can later be integrated into a PIC package.

Referring now to FIG. 5B, a cross-sectional illustration of the substrate 540 after a first prepolymer 524 is dispensed into the cavity 541 is shown, in accordance with an embodiment. In an embodiment, the first prepolymer 524 may be a material with a relatively low index of refraction. The first prepolymer 524 may substantially fill the cavity 541.

Referring now to FIG. 5C, a cross-sectional illustration of the substrate 540 after a second prepolymer 523 is dispensed over the first prepolymer 524 is shown, in accordance with an embodiment. The second prepolymer 523 may have a second index of refraction that is higher than the index of refraction of the first prepolymer 524. In some embodiments, surface tension may allow for the second prepolymer 523 to remain segregated over the first prepolymer 524. In the illustrated embodiment, the thickness of the second prepolymer 523 is thinner than the thickness of the first prepolymer 524. Though, in other embodiments, the first prepolymer 524 may be the same thickness or thinner than the second prepolymer 523.

Referring now to FIG. 5D, a cross-sectional illustration of the substrate 540 after an additional first prepolymer 524 is provided over the surface of the second prepolymer 523. The two first prepolymers 524 above and below the second prepolymer 523 may be substantially similar to each other in thickness and in composition. Though, the first prepolymers 524 may have different thicknesses in some embodiments. The first prepolymer 524 over the second prepolymer 523 may remain segregated over the second prepolymer 523 due to surface tension effects.

Referring now to FIG. 5E, a cross-sectional illustration of the GRIN lens 520 after a diffusion process is shown, in accordance with an embodiment. In an embodiment, the first prepolymer 524 and the second prepolymer 523 may be miscible polymer precursors. As such, they diffuse similar to how liquids diffuse. Accordingly, a smooth composition gradient between the composition of the first prepolymer 524 and the composition of the second prepolymer 523 can be obtained, as shown in the adjacent graph 550. That is, there may not be discrete layers of different compositions in some embodiments. After the diffusion, a laser or UV irradiation of the GRIN lens 520 can be implemented in order to cure the prepolymers so that they form a solid polymer with a composition gradient. The GRIN lens 520 can then be removed from the substrate 540 and integrated into a PIC package, as will be described in greater detail below.

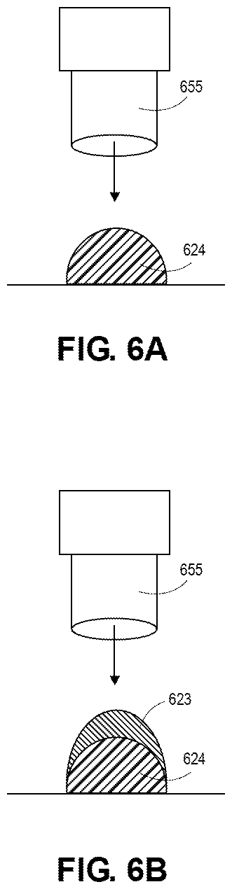

Referring now to FIGS. 6A and 6B, a pair of cross-sectional illustrations depicting another method of forming a GRIN lens is shown, in accordance with an embodiment. The process shown in FIGS. 6A and 6B includes an additive manufacturing process to form the GRIN lens. Additive manufacturing processes may include 3D printing and/or micro dispensing (e.g., ink-jetting or aerosol printing).

Referring now to FIG. 6A, a cross-sectional illustration of a dispensing nozzle 655 is shown, in accordance with an embodiment. The dispensing nozzle 655 may be capable of providing a first droplet 624 on a surface. In an embodiment, the dispensing nozzle 655 is an ink-jetting nozzle, an aerosol printing nozzle, or the like. In an embodiment, the first droplet 624 may have a first composition.

Referring now to FIG. 6B, a cross-sectional illustration of a dispensing nozzle 655 after dispensing a second droplet 623 over the first droplet 624 is shown, in accordance with an embodiment. The second droplet 623 may have a different material composition than the first droplet 624. Repeated dispensing of the first droplet 624 and the second droplet 623 may result in the formation of a structure with a compositional gradient similar to embodiments described above. For example, diffusion between droplets may result in an index of refraction gradient suitable for a GRIN lens. In the case of aerosol printing, higher resolution may be provided. By adjusting the gas/liquid flow for each material, the mass ratio of the materials can be manipulated. With this method, the refractive index of the deposited mixture is tuned.

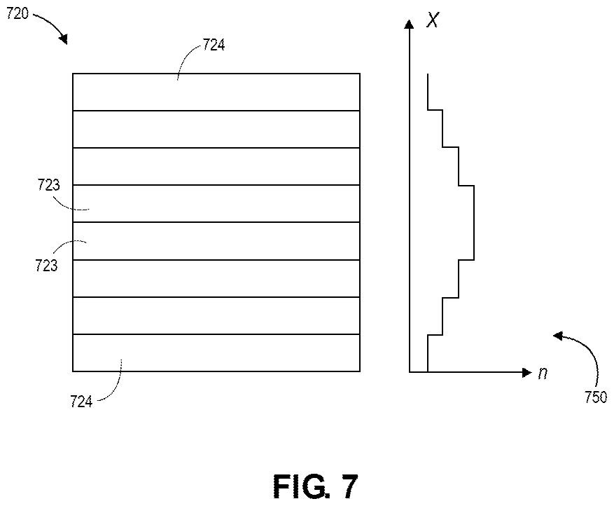

Referring now to FIG. 7, a cross-sectional illustration of a GRIN lens 720 is shown, in accordance with an embodiment. As shown, the GRIN lens 720 comprises a plurality of stacked layers. The top and bottom layers may be a first material 724, and the middle layers may be a second material 723. As shown in the graph 750 on the right, the second material 723 may have a higher index of refraction than the first material 724. The layers between the first material 724 and the second material 723 may be graded. As such, a graph 750 with a step-wise function may be provided in some embodiments. Though, diffusion between layers may somewhat smooth the graph 750 in some instances.

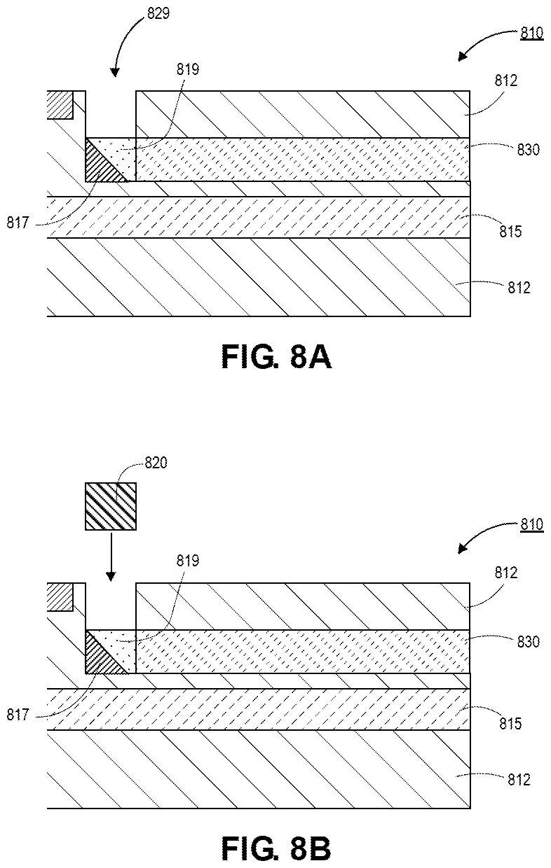

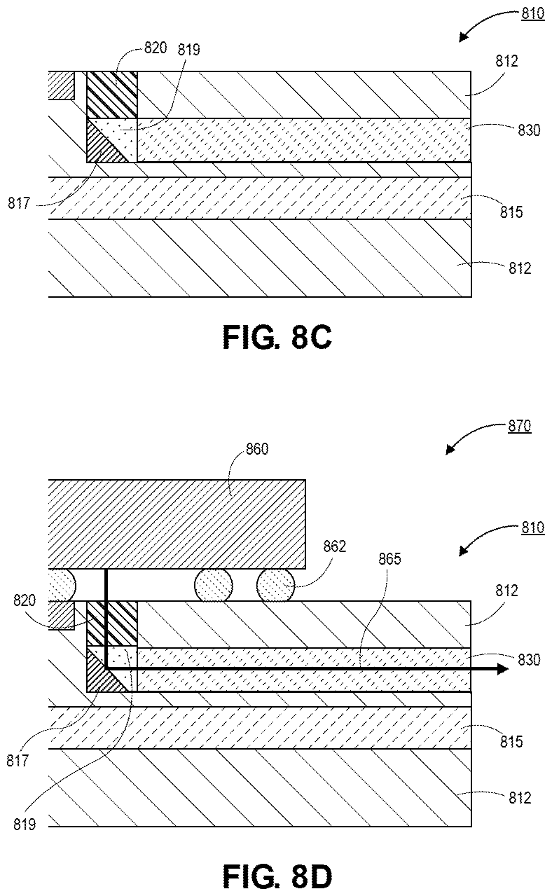

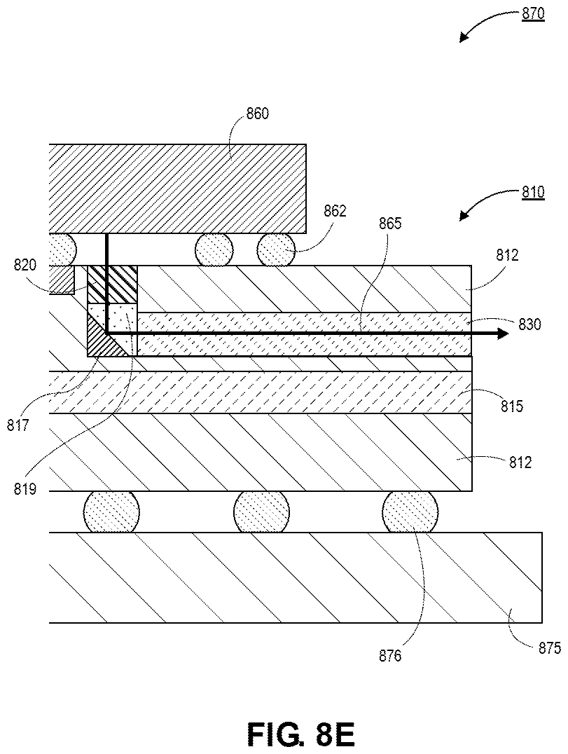

Referring now to FIGS. 8A-8E, a series of cross-sectional illustrations depicting a process for forming a PIC package 870 is shown, in accordance with an embodiment. In the illustrated embodiment, the GRIN lens 720 is inserted as a discrete component. Though, in some embodiments, the GRIN lens 720 may be fabricated directly on the PIC package 870 for a fully integrated solution.

Referring now to FIG. 8A, a cross-sectional illustration of a package substrate 810 is shown, in accordance with an embodiment. In an embodiment, the package substrate 810 comprises a core 815 and buildup layers 812 above and below the core 815. The core 815 may be a glass core, an organic core, or the like. In an embodiment, the buildup layers 812 may be buildup film, molding materials, or the like.

In the illustrated embodiment, an optical fiber 830 (e.g., a glass fiber) is embedded in the buildup layers 812 above the core 815. Such an embodiment will be similar in structure to the embodiment described in greater detail above with respect to FIG. 3. Though, other architectures similar to those in FIG. 2 or FIG. 4 may also be formed with similar processing operations with modifications to the position of the optical fiber 830 and the orientation of the GRIN lens 820.

In an embodiment, a cavity 829 may be provided through the buildup layers 812. A mirror 817 may be provided at the bottom of the cavity 829. The mirror 817 is oriented so that a vertical optical signal is turned in the horizontal direction so that the optical signal enters the optical fiber 830. In an embodiment, an optically clear fill 819 may be provided over the mirror 817.

Referring now to FIG. 8B, a cross-sectional illustration of the package substrate 810 during the insertion of the GRIN lens 820 is shown, in accordance with an embodiment. As indicated by the arrow, the GRIN lens 820 is inserted down into the cavity 829. The GRIN lens 820 may be similar to any of the GRIN lens architectures described in greater detail herein. For example, the GRIN lens 820 may have a radial composition gradient with a center that has a higher index of refraction than the outer edge of the GRIN lens 820. The GRIN lens 820 may have substantially planar top and bottom surfaces that are parallel to each other.

Referring now to FIG. 8C, a cross-sectional illustration of the package substrate 810 after the GRIN lens 820 is inserted into the cavity 829 is shown, in accordance with an embodiment. As shown, the GRIN lens 820 may be supported from below by the optically clear fill 819.

Referring now to FIG. 8D, a cross-sectional illustration of a PIC package 870 is shown, in accordance with an embodiment. As shown, a PIC 860 may be attached over the package substrate 810 with interconnects 862. The PIC 860 may have a light source (e.g., laser) or a light detector (e.g., photodiode) that is optically coupled to a path of an optical signal 865. The signal path for the optical signal 865 may pass through the GRIN lens 820, reflect off of the mirror 817, and be directed along the optical fiber 830.

Referring now to FIG. 8E, a cross-sectional illustration of the PIC package 870 after a board 875 is attached is shown, in accordance with an embodiment. The board 875 may be a PCB or the like. Further, interconnects 876 may be used to attach the package substrate 810 to the board 875.

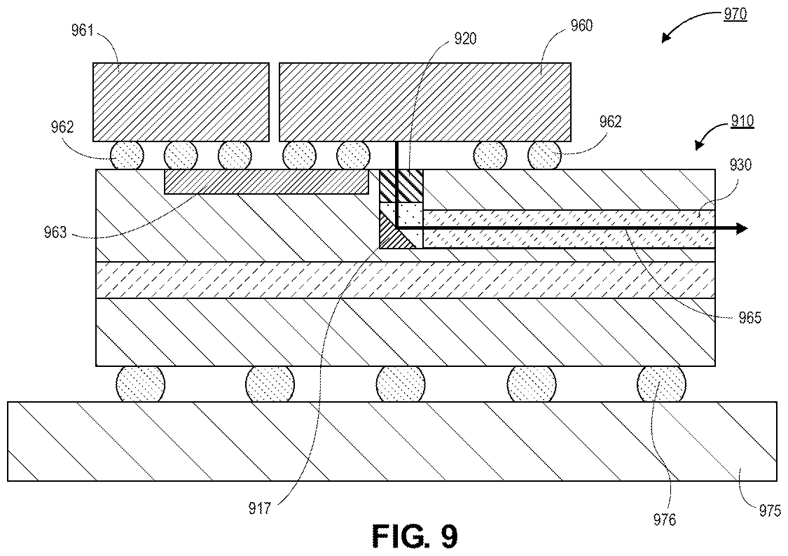

Referring now to FIG. 9, a cross-sectional illustration of a PIC package 970 is shown, in accordance with an embodiment. In an embodiment, the PIC package 970 may comprise a board 975, such as a PCB or the like. Interconnects 976 may couple the board 975 to a package substrate 910. In an embodiment, a path of an optical signal 965 may pass from a PIC 960, through a GRIN lens 920, reflect off of a mirror 917, and propagate along an optical fiber 930. The structure of the optical path is similar to that of the optical path shown in FIG. 3. Though, it is to be appreciated that any configuration described herein may be integrated with the structure of the PIC package 970.

In an embodiment, the PIC 960 may be coupled to the package substrate 910 using interconnects 962. Further, the PIC 960 may be electrically coupled to a compute die 961, such as a central processing unit (CPU), a graphics processing unit (GPU), an XPU, a system on a chip (SoC), an application specific integrated circuit (ASIC), or the like. For example, an embedded bridge die 963 may have high density routing in order to electrically couple the PIC 960 to the compute die 961.

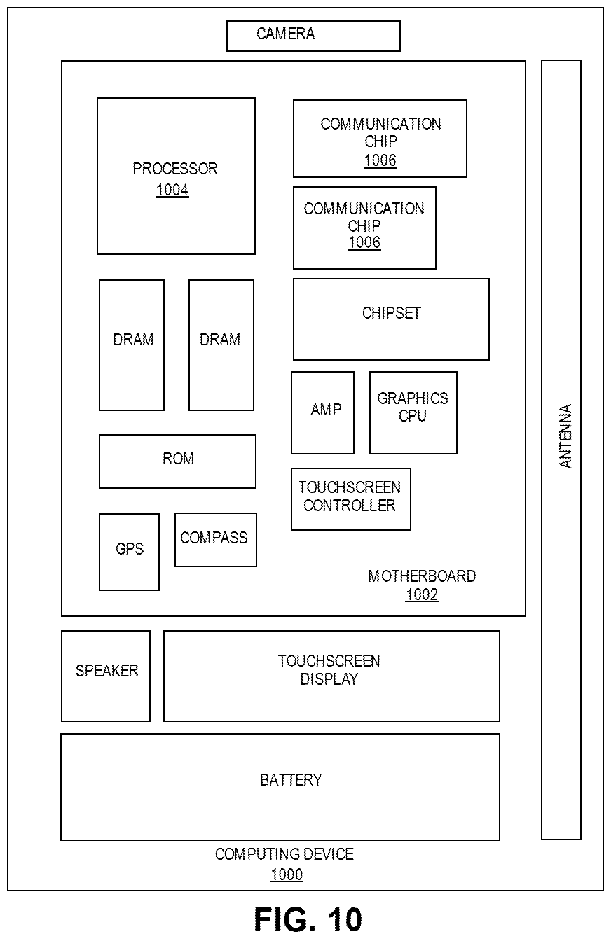

FIG. 10 illustrates a computing device 1000 in accordance with one implementation of the invention. The computing device 1000 houses a board 1002. The board 1002 may include a number of components, including but not limited to a processor 1004 and at least one communication chip 1006. The processor 1004 is physically and electrically coupled to the board 1002. In some implementations the at least one communication chip 1006 is also physically and electrically coupled to the board 1002. In further implementations, the communication chip 1006 is part of the processor 1004.

These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 1006 enables wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1006 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 1000 may include a plurality of communication chips 1006. For instance, a first communication chip 1006 may be dedicated to shorter range wireless communications such as Wi-Fi and Bluetooth and a second communication chip 1006 may be dedicated to longer range wireless communications such as GPS, EDGE, GPRS, CDMA, WiMAX, LTE, Ev-DO, and others.

The processor 1004 of the computing device 1000 includes an integrated circuit die packaged within the processor 1004. In some implementations of the invention, the integrated circuit die of the processor may be part of an electronic package that comprises a PIC that is optically coupled to an optical fiber through a GRIN lens, in accordance with embodiments described herein. The term “processor” may refer to any device or portion of a device that processes electronic data from registers and/or memory to transform that electronic data into other electronic data that may be stored in registers and/or memory.

The communication chip 1006 also includes an integrated circuit die packaged within the communication chip 1006. In accordance with another implementation of the invention, the integrated circuit die of the communication chip may be part of an electronic package that comprises a PIC that is optically coupled to an optical fiber through a GRIN lens, in accordance with embodiments described herein.

In an embodiment, the computing device 1000 may be part of any apparatus. For example, the computing device may be part of a personal computer, a server, a mobile device, a tablet, an automobile, or the like. That is, the computing device 1000 is not limited to being used for any particular type of system, and the computing device 1000 may be included in any apparatus that may benefit from computing functionality.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

Example 1: a package substrate, comprising: a substrate; an optical fiber in the substrate; and a lens optically coupled to the optical fiber, wherein the lens is a gradient index (GRIN) lens.

Example 2: the package substrate of Example 1, wherein the GRIN lens has an index of refraction at a radial center of the lens that is higher than an index of refraction at a radial edge of the lens.

Example 3: the package substrate of Example 1 or Example 2, wherein the optical fiber is optically coupled to the lens by at least a mirror.

Example 4: the package substrate of Examples 1-3, wherein the optical fiber is embedded in a buildup layer of the package substrate.

Example 5: the package substrate of Examples 1-4, wherein the optical fiber is embedded in a core of the package substrate.

Example 6: the package substrate of Example 5, wherein the core is a glass core.

Example 7: the package substrate of Examples 1-6, wherein the lens has planar surfaces that are parallel with each other.

Example 8: the package substrate of Examples 1-7, wherein the lens is optically coupled to a photonics integrated circuit (PIC).

Example 9: the package substrate of Example 8, wherein the lens is within a footprint of the PIC.

Example 10: the package substrate of Examples 1-9, wherein the package substrate is part of a computer system for a personal computer, a server, a mobile device, a tablet, or an automobile.

Example 11: an optical system, comprising: a photonics integrated circuit (PIC); and a package substrate, wherein the package substrate comprises: an optical fiber; and a lens with a radially graded index of refraction, wherein surfaces of the lens configured to be incident to light to or from the PIC are substantially planar, and wherein the PIC is optically coupled to the optical fiber by at least the lens.

Example 12: the optical system of Example 11, wherein the lens comprises a first polymer with a first index of refraction at a radial center of the lens and a second polymer with a second index of refraction at a radial edge of the lens.

Example 13: the optical system of Example 12, wherein a gradient mixture of the first polymer and the second polymer is provided between the outer surface of the first polymer and an inner surface of the second polymer.

Example 14: the optical system of Example 12, wherein a gradient from the first index of refraction to the second index of refraction is provided by a plurality of discrete polymer layers with different material compositions.

Example 15: the optical system of Examples 11-14, wherein the optical fiber is coupled to the lens by at least a mirror.

Example 16: the optical system of Examples 11-15, wherein the optical fiber is in a core of the package substrate or within a buildup layer of the package substrate.

Example 17: the optical system of Examples 11-16, wherein the PIC is electrically coupled to a compute die through an embedded bridge.

Example 18: the optical system of Examples 11-17, wherein the optical system is part of a personal computer, a server, a mobile device, a tablet, or an automobile.

Example 19: a computing system, comprising: a board; a package substrate coupled to the board, wherein the package substrate comprises: an optical waveguide; a gradient index (GRIN) lens optically coupled to the optical waveguide, wherein surfaces configured to be incident to optical communication signals are substantially planar; and a photonics integrated circuit (PIC) optically coupled to the optical waveguide by at least the GRIN lens.

Example 20: the computing system of Example 19, wherein the computing system is part of a personal computer, a server, a mobile device, a tablet, or an automobile.

What is claimed is:

1. A package substrate, comprising:
a substrate;
an optical fiber in the substrate; and
a lens optically coupled to the optical fiber, wherein the lens is a gradient index (GRIN) lens.

2. The package substrate of claim 1, wherein the GRIN lens has an index of refraction at a radial center of the lens that is higher than an index of refraction at a radial edge of the lens.

3. The package substrate of claim 1, wherein the optical fiber is optically coupled to the lens by at least a mirror.

4. The package substrate of claim 1, wherein the optical fiber is embedded in a buildup layer of the package substrate.

5. The package substrate of claim 1, wherein the optical fiber is embedded in a core of the package substrate.

6. The package substrate of claim 5, wherein the core is a glass core.

7. The package substrate of claim 1, wherein the lens has planar surfaces that are parallel with each other.

8. The package substrate of claim 1, wherein the lens is optically coupled to a photonics integrated circuit (PIC).

9. The package substrate of claim 8, wherein the lens is within a footprint of the PIC.

10. The package substrate of claim 1, wherein the package substrate is part of a computer system for a personal computer, a server, a mobile device, a tablet, or an automobile.

11. An optical system, comprising:
a photonics integrated circuit (PIC); and
a package substrate, wherein the package substrate comprises:
an optical fiber; and
a lens with a radially graded index of refraction, wherein surfaces of the lens configured to be incident to light to or from the PIC are substantially planar, and wherein the PIC is optically coupled to the optical fiber by at least the lens.

12. The optical system of claim 11, wherein the lens comprises a first polymer with a first index of refraction at a radial center of the lens and a second polymer with a second index of refraction at a radial edge of the lens.

13. The optical system of claim 12, wherein a gradient mixture of the first polymer and the second polymer is provided between the outer surface of the first polymer and an inner surface of the second polymer.

14. The optical system of claim 12, wherein a gradient from the first index of refraction to the second index of refraction is provided by a plurality of discrete polymer layers with different material compositions.

15. The optical system of claim 11, wherein the optical fiber is coupled to the lens by at least a mirror.

16. The optical system of claim 11, wherein the optical fiber is in a core of the package substrate or within a buildup layer of the package substrate.

17. The optical system of claim 11, wherein the PIC is electrically coupled to a compute die through an embedded bridge.

18. The optical system of claim 11, wherein the optical system is part of a personal computer, a server, a mobile device, a tablet, or an automobile.

19. A computing system, comprising:
a board;
a package substrate coupled to the board, wherein the package substrate comprises:
an optical waveguide;
a gradient index (GRIN) lens optically coupled to the optical waveguide, wherein surfaces configured to be incident to optical communication signals are substantially planar; and
a photonics integrated circuit (PIC) optically coupled to the optical waveguide by at least the GRIN lens.

20. The computing system of claim 19, wherein the computing system is part of a personal computer, a server, a mobile device, a tablet, or an automobile.
